(19) United States
(12) Patent Application Publication
(10) Pub. No.: US 2007/0104999 A1
(43) Pub. Date: May 10, 2007

(54) Solid Fuel Devices for Fuel Cells

(76) Inventors: Gavin P. Towler, Inverness, IL (US); Anil R. Oroskar, Oakbrook, IL (US); Kurt M. Vanden Bussche, Lake in the Hills, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/619,271

(22) Filed: Jan. 3, 2007

Related U.S. Application Data
(62) Division of application No. 10/648,562, filed on Aug. 26, 2003.
(60) Provisional application No. 60/451,314, filed on Feb. 28, 2003.

(51) Int. Cl. H01M 8/04

(52) U.S. Cl. 429/34

(57) ABSTRACT

A fuel cartridge for a fuel cell, and a fuel cell design is presented wherein the system allows the intermittent use of the fuel in the cartridge. The fuel cell and cartridge provide improved design characteristics that improve the portability of fuel cells for use in portable electronic devices

### CROSS-REFERENCE TO RELATED APPLICATION

This application is a Division of copending application Ser. No. 10/648,562 filed Aug. 26, 2003, and claims priority Application Ser. No. 60/451,314, filed Feb. 28, 2003, the contents of which are hereby incorporated by reference in its entirety.

### FIELD OF THE INVENTION

This invention relates to fuel cells. Specifically, this invention relates to containers for holding solid fuels for fuel cells and devices for loading the containers.

### BACKGROUND OF THE INVENTION

Fuel cells have developed as a method of generating electricity from chemicals. Some early development focused on using hydrogen as a clean fuel source for producing power. Work has been done on the storage and generation of hydrogen for use in fuel cells and is disclosed in U.S. Pat. No. 6,057,051, U.S. Pat. No. 6,267,229, U.S. Pat. No. 6,251,349, U.S. Pat. No. 6,459,231, and U.S. Pat. No. 6,514,478. Hydrogen is a high energy, low pollution fuel, however, the storage of this fuel is cumbersome, both from an energy density and safety point of view.

The difficulty of storing hydrogen has led to looking at generating hydrogen from more useful fuels. Liquid fuels containing a relatively high amount of hydrogen that can be generated through reforming have received significant attention. Reforming of a fuel is expensive, and adds significantly to the complexity and size of a unit using fuel cells for power generation. Reformers and methods of reforming liquid fuels have been developed, as shown in U.S. Pat. No. 4,716,859, U.S. Pat. No. 6,238,815, and U.S. Pat. No. 6,277,330. Therefore, there is significant interest in fuel cells that can use a hydrogen rich fuel that can be processed directly over a fuel cell electrode. This separates the fuel cells into two general categories: an indirect or reformer fuel cell wherein a fuel, usually an organic fuel, is reformed and processed to produce a hydrogen rich, and substantially carbon monoxide (CO) free feed stream to the fuel cell; and a direct oxidation fuel cell wherein an organic fuel is directly fed to the fuel cell and oxidized without any chemical reforming. Direct oxidation fuel cells can use either a liquid feed design or a vapor feed design, and preferably the fuels, after oxidation in the fuel cell, yield clean combustion products like water and carbon dioxide (CO₂).

In early development of direct methanol fuel cells (DMFC), using gaseous methanol required a high heat, which brought about the degradation of the fuel cell membranes. This led to the development of DMFCs using methanol in the liquid phase, as shown in U.S. Pat. No. 5,599,638, and U.S. Pat. No. 6,248,460. However, the liquid phase presents drawbacks also, not the least of which is cross over of the membrane by the methanol and contamination of the cathode.

As with vapor phase fuel cells, liquid phase fuel cells also have handling problems. Specific problems include some orientations of the fuel cells or portable devices allow liquid fuel to flow out of openings for releasing waste gases, and liquid fuel cells have the problem of the high concentration of liquid methanol permeating through to be oxidized at the cathode which reduces fuel cell efficiency. Also, it would be convenient for a user of a portable electronic device to have fuel in cartridges and a device for handling the cartridges to limit the possibility of fuel spillage, including leakage from any gaseous or liquid compounds generated.

### SUMMARY OF THE INVENTION

The present invention is an apparatus for containing fuel and for controlling the release of the fuel from the apparatus. The apparatus comprises a first compartment for holding a solid fuel, and a second compartment for holding a liquid activation agent. The first compartment is in fluid communication with the second compartment, and the communication is controlled by a means for restricting the fluid communication between the first and second compartments. In one embodiment, the apparatus further includes means for communicating with the means for restricting the fluid flow between the first and second compartments

Another aspect of the invention is a receptacle for holding the fuel containing apparatus. The receptacle has a housing with a fuel cartridge tray slideably attached to the housing. The housing defines a sealable space wherein the fuel cartridge resides, and includes a discharge port for fuel from the cartridge to exit. The receptacle further includes means for communicating with the fuel cartridge.

A third aspect of the invention is a fuel cell. The fuel cell comprises a system to bring a solid fuel in close proximity to the anodes. The fuel cell comprises a housing with at least one membrane electrode assembly (MEA) positioned within the housing, and with the anode side facing a space defined for a fuel cartridge within the housing. The fuel cell further includes a fuel cartridge tray for loading a fuel cartridge into the space within the housing, and a door to cover a fuel cartridge inlet port. The door further includes a seal to provide a sealed space in which a fuel cartridge facing an anode resides.

Other objects, advantages and applications of the present invention will become apparent to those skilled in the art after the following detailed description of the invention.

### BRIEF DESCRIPTION OF THE FIGURES

FIG. 1 is a diagram of a fuel cartridge with a valve for controlling the mixing of water with the solid fuel;

FIG. 2 is a diagram of a second embodiment of a fuel cartridge;

FIG. 3 is a diagram of a third embodiment of a fuel cartridge;

FIG. 4 is a diagram of a fuel cartridge receptacle and holding device;

FIG. 5 is a side view of a fuel cartridge receptacle and holding device with the fuel cartridge in the receptacle tray; and

FIG. 6 is a diagram of a fuel cell in cross section showing the MEAs and the fuel cartridge tray.

### DETAILED DESCRIPTION OF THE INVENTION

Fuel cells are useful devices for supplying electronic devices with a steady source of electrical power. However, the fuel cells require a steady supply of fuel, and for portable electronic devices, a fuel that is in a self-contained cartridge is desirable. The cartridge should also be attachable to the fuel cell in such a manner that a seal is provided such that the fuel cell anode compartment is sealed gas and liquid tight while open to the full in the cartridge.

In operation, the fuel cell generates electricity as long as fuel is supplied to the fuel cell. The fuel cell does not turn off when the power is no longer needed, but continues to run when fuel is fed to the fuel cell. However, for many portable electronic devices, intermittent electrical power is needed. Therefore, a means of controlling the flow of fuel to the fuel cell is needed, and a method of controlling the intermittent power required to be generated by a fuel cell is needed. A battery provides the ability to use the electronic device intermittently, while not using power when the device is turned off. However, a battery also has a limited life and needs to be replaced or recharged on a regular basis, and needs to be plugged into a constant stationary source of power for recharging. A fuel cell provides for a longer portable life but has less ability to automatically generate the amount of power needed at a given time. By providing a fuel cell with a rechargeable battery, a portable electronic device can be run indefinitely with a supply of fuel cell cartridges. A fuel cell having a regulated flow of fuel to the fuel cell can provide intermittent power to charge a battery. A control system providing a signal indicating the battery's power level provides a signal to the fuel cell cartridge. When the battery's power level is below a preset lower limit, a low power signal is sent to the fuel cell cartridge. The fuel cell cartridge activates a means for allowing fuel to flow to the fuel cell. In particular, the fuel cell cartridge allows mixing of an activating agent with a solid fuel to generate hydrogen. The activating agent continues to mix with the solid fuel and the hydrogen continues to be generated until the fuel cell cartridge receives a signal indicating that the battery's power is at or above a preset upper limit. When the battery's power is at or above the preset upper limit, a signal is sent to the fuel cell cartridge, and the fuel cell cartridge deactivates the means for allowing fuel to flow to the fuel cell. Typically, the preset maximum is below the total recharge of the battery to prevent wasting fuel by running the fuel cell when no more recharging is taking place.

Fuel cartridges are known and provide for charges of fuel to devices. Examples are found in U.S. Pat. No. 4,261,956; U.S. Pat. No. 6,267,299; U.S. Pat. No. 6,447,945; and U.S. Pat. No. 6,460,766, which are incorporated by reference in their entirety. Fuel cartridges currently have the drawback of having no control over the amount of fuel delivered. This drawback limits the design of anodes in fuel cells and requires ducting and valves within the fuel cell to direct and control fuel flow. A feature of this invention is the ability to bring the solid fuel and fuel cell anode in close proximity, as well as controlling the release of fuel to the anode.

The present invention comprises a fuel cartridge for use in a fuel cell that provides for intermittent control of the flow of fuel to the fuel cell. The fuel cartridge holds a solid fuel, which when exposed to water generates a gaseous fuel for use in the fuel cell. One embodiment of the fuel cartridge is shown in FIG. 1, and comprises a housing 10 with a first compartment 12, a second compartment 14, a conduit 16 connecting the first 12 and second 14 compartments and providing fluid communication between the first 12 and second 14 compartments, and a means 18 for restricting the fluid communication between the first 12 and second 14 compartments disposed within the conduit. The first compartment 12 has an inlet port 13 in fluid communication with the conduit 16, and at least one outlet port 15 for the egress of hydrogen. The second compartment 14 has an outlet port 17 in fluid communication with the conduit 16. The use of a solid fuel for a fuel cell needs an activating agent for the fuel to generate a gaseous component that is reactive at the anode. An example of an activating agent and solid fuel is water and lithium hydride solid fuel. The fuel cartridge receives a signal from a fuel cell controller. The signal triggers opening of the restriction means 18 in the conduit 16 allowing the activating agent to flow from the second compartment 14 to the first compartment 12. When an activation agent, such as water is added to the solid fuel, the solid fuel reacts and releases hydrogen (H₂). The hydrogen exits the first compartment through a hydrophobic membrane 20 over the outlet ports 15 of the first compartment 12. In the first embodiment, the fuel cartridge has an overall rectangular prismatic shape and the first compartment 12 within the cartridge also has a rectangular prismatic shape. The shape of the cartridge may take a variety of forms, but it is envisioned that the preferred embodiment will be a relatively thin box having a generally rectangular shape. An outlet port 15 for the first compartment 12 comprises one of the faces of the first compartment 12. The hydrophobic membrane 20 prevents moisture generated at the fuel cell anode from entering the solid fuel chamber of the fuel cartridge. In an alternate embodiment, the first compartment 12 has two faces for outlet ports 15, and has a hydrophobic membrane 20 over each of the two faces of the first compartment 12, for a more rapid transfer of hydrogen out of the first compartment 12. In one embodiment, the means 18 for restricting flow is a valve. Other restricting means include membranes having adjustable permeabilities, and flaps for shutting the conduit.

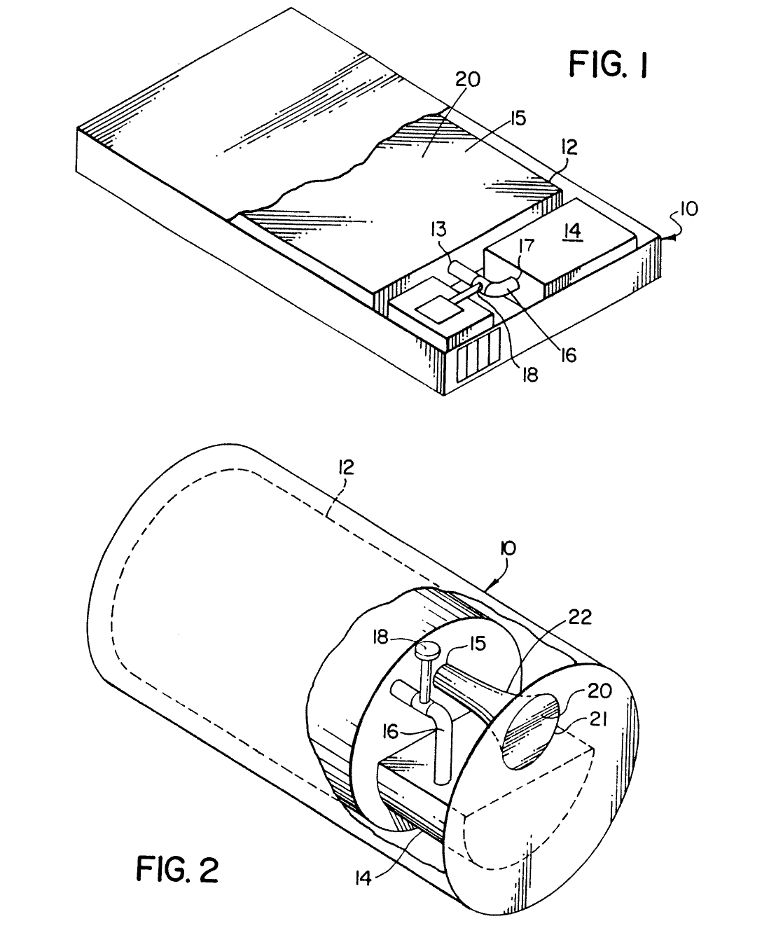

An alternate embodiment is a cylindrically shaped fuel cartridge, as shown in FIG. 2. The cartridge comprises a cylindrical housing 10 with a first compartment 12 for holding a solid fuel, a second compartment 14 for holding a liquid activating agent under pressure, a conduit 16 providing fluid flow between the second compartment 14 and the first compartment, and a means 18 for restricting the flow of the liquid activating agent from the second compartment 14 to the first compartment 12. The hydrogen generated as a result of the liquid activating agent contacting the solid fuel exits the first compartment 12 through an outlet port 15 to a fuel conduit 22. The fuel conduit 22 includes an outlet 21 covered with a hydrophobic membrane 20.

In one embodiment, the outlet 21 for the hydrogen includes a gasket (not shown) encircling the outlet 21. The gasket provides a seal between the fuel cartridge and a conduit connecting the fuel cartridge to the fuel cell, preventing leaks of hydrogen from a system of fuel cell and fuel cell cartridge. The gasket can be made of any elastomeric, or equivalent, material that is impermeable to hydrogen and water, and is deformable such that when the cartridge is pressed into position, the gasket forms a seal. Materials for the gasket include for example, natural and synthetic rubbers, and soft plastics.

Alternate shapes and designs are possible and are intended to be covered by the invention. The shapes and designs are subject to convenience and the matching of the cartridge to a fuel cartridge receptacle component of a fuel cell. Alternate shapes and designs also allow for multiple outlets for the hydrogen from the first compartment.

The fuel for use in the fuel cell device is preferably a metal hydride, that reacts upon exposure to an activating agent releasing hydrogen. Solid fuels include, but are not limited to, lithium hydride (LiH), sodium hydride (NaH), potassium hydride (KH), beryllium hydride (BeH), magnesium hydride (MgH₂), calcium hydride (CaH₂), and mixtures thereof. The metal hydride can also be dispersed in carbon for providing stability of the fuel when the fuel is residing in the first compartment. While the invention is described with metal hydrides as a possible fuel, other fuels such as solid methanol fuels are applicable, and especially methanol fuels with adsorbents for adsorbing CO₂.

The solid fuel is in a water tight compartment and reacts with a liquid component, or activating agent, that brings about the release of hydrogen gas (H2). Preferably the liquid is water, but the liquid can also be aqueous solutions containing a dilute acid, or a dilute base. Acids include, but are not limited to hydrochloric acid (HCl), nitric acid (HNO₃), and sulfuric acid (H₂SO₄). Strong bases include, but are not limited to, sodium hydroxide (NaOH) and potassium hydroxide (KOH). The aqueous solutions are preferably dilute solutions of the acids or bases, and have a concentration of no more than 0.1 molar.

Controlled release of the activating agent controls the rate of release of gaseous fuel to the fuel cell, which in turn controls the rate of power generation from the fuel cell. As the fuel cell generates electrical power continuously with the feed of fuel, the fuel cell is preferably designed to charge a battery, and shut off when the battery reaches a preset level of charge. When the battery discharges to a second preset level, the flow of fuel to the fuel cell is resumed to run the fuel cell and recharge the battery. In this manner, only sufficient solid fuel is used to meet the needs of the electronic device without continuous consumption of the solid fuel.

The controlled release is accomplished through a valve 18, or other means, for restricting the flow of the liquid activating agent to the solid fuel. The valve 18, or other means, can open or close electronically or mechanically to allow the flow of the liquid through a conduit connecting the second compartment 14 to the first compartment 12. Optionally, the cartridge further includes a connection means for communicating between a controller (not shown) and the fuel cartridge valve 18. The cartridge includes an operator for opening and closing the restriction means, or valve 18. The generator receives a signal to open or close the valve through a communication means. The communication means allows communication between the cartridge and the fuel cell or a fuel cell controller providing the signal to the operator for opening or closing the valve. Preferably, the cartridge includes an electronic bus having contacts with a complementary system enabling electronic communication between the controller and the valve 18. Although an electronic bus is preferred, a mechanical linkage is also envisioned by this invention, and intended to be covered.

The liquid activating agent flows under pressure from the second compartment 14 to the first compartment 12. The housing 10 can be oriented such that the outlet to the second compartment 14 is always oriented at the bottom, or at a lower region, of the compartment. However, an alternate means for maintaining pressure and keeping the liquid under pressure, and enabling the liquid to flow out of the compartment outlet without pressurizing gas escaping is to affix a flexible bladder (not shown) within the second compartment 14. The flexible bladder separates the liquid and pressurizing gas, and expands as the liquid exits the compartment 14. The bladder is affixed to a position within the compartment, such that the bladder when expanded does not cover the outlet port of the second compartment 14. This allows for any orientation of the cartridge.

The fuel cartridge further includes means for communicating between the fuel cartridge and the fuel cell. An example includes electrical contacts, such that when the fuel cartridge is in a receptacle and the receptacle is in a closed position, then contact is made between the electrical contacts on the cartridge and contacts in the receptacle. The receptacle may be a part of a fuel cell, or a device attached to a fuel cell and provide a proper connection between the fuel cell or a fuel cell controller and the fuel cartridge. The contacts allow for electrical communication between the fuel cell and the fuel cartridge. The electrical communication is for transmitting a signal to the fuel cartridge valve 18, indicating that the valve should be in an open or closed position. Alternately, the means for communicating between the fuel cartridge and the fuel cell receptacle may be a mechanical linkage.

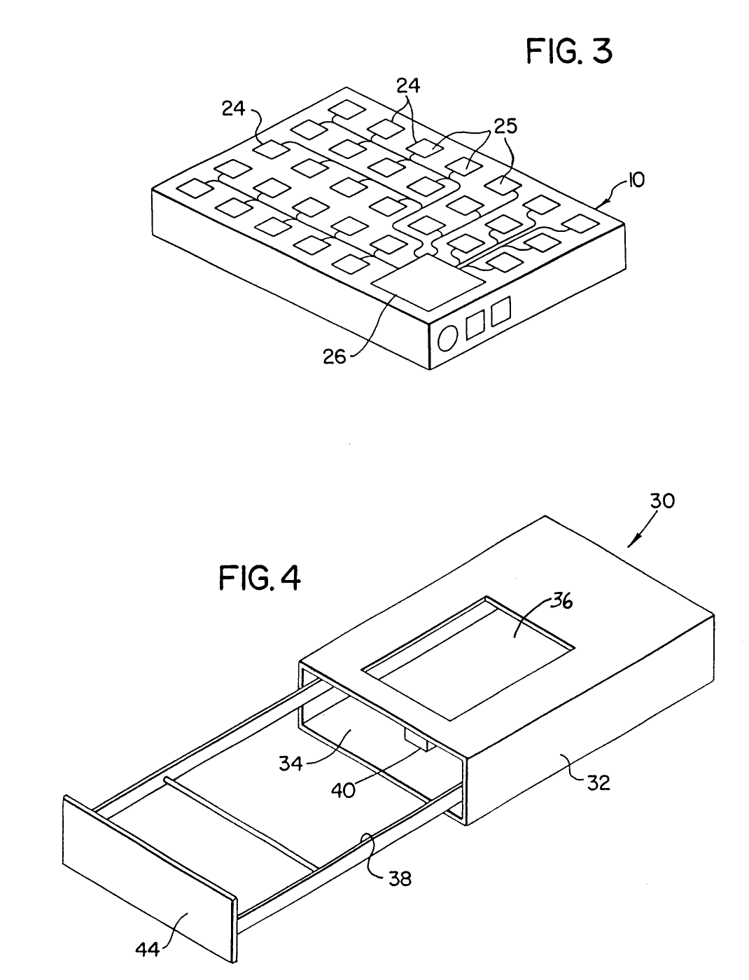

An alternate embodiment of the present invention includes an array of containers within a cartridge, as shown in FIG. 3. The fuel cartridge comprises a housing 10 for holding a plurality of containers 24, or chambers, with each container holding a preset amount of solid fuel. Each container 24 includes an opening for the entrance of an activating agent, i.e. moisture, and the exit of gaseous fuel for the fuel cell. The opening of each container is sealed with a cover 25 that is removable upon receiving an appropriate signal. The cartridge further includes a means 26 for selecting an individual container to be unsealed.

The means 26 can be any switching means, such as a small computer chip, for sending a signal to an individual container 24. Preferably, the cover 25 is opened through means such as an electrical current that heats the cover and opens the container. The means for opening the cover may be an electrical resistance element for generating heat, or a small amount of a chemical that upon initiation with an electrical current reacts to heat and open the cover.

Alternately, the cover may include a bimetallic material that preferentially bends in one direction upon heating. An alternate means for sealing the cover to the container is the use of a low temperature adhesive, such that upon heating the adhesive strength is reduced sufficiently to open the cover. Still another alternate means for sealing the cover is to use a low melting point wax or thermoplastic material that can be heated and melted to open the container. Preferably, the low melting point wax or thermoplastic will melt at a temperature above the operating temperature of the electronic device. A preferred temperature range is from about 100° C. to about 200° C.

While a cartridge as shown in FIG. 3 is a rectangular grid array, the housing 10 and array of cylinders are not limited to those shown. The housing may include a cylindrical shape with the containers formed in a spiral wound array, or the cartridge can be of any design, but preferably is a design that is convenient and adapted to an appropriate fuel cartridge receptacle in a fuel cell.

Apparatuses of the type presented in FIG. 3, are also applicable as fuel cartridges for DMFCs. Solid fuels that work with this apparatus include fuels for generating hydrogen, as well as fuels for generating gaseous methanol. When the fuels include solid fuels for generating methanol, the cartridge may further include an adsorbent compartment. The adsorbent compartment contains a material for adsorbing carbon dioxide generated at the anode of the fuel cell.

A further part of this invention includes an apparatus, or receptacle, for holding a fuel cartridge. The fuel cartridge for use in a fuel cell is sized and shaped to fit such a fuel cartridge receptacle. One such receptacle 30 is shown in FIG. 4. The receptacle 30 includes a housing 32 having an insertion port 34 for inserting a fuel cartridge (not shown), and at least one discharge port 36 for the exit of a gaseous fuel from the fuel cartridge. In one embodiment of this invention, the receptacle 30 is shaped to hold a rectangularly shaped fuel cartridge. The apparatus includes a fuel cartridge tray 38 for holding the fuel cartridge. The fuel cartridge tray 38 is slideably affixed to the housing 32 and moves between an open position, for inserting a new cartridge or removing a spent cartridge, and a closed position wherein the tray 38 resides within the housing 32. The fuel cartridge receptacle 30 further includes a means for pressing the outlet ports of the fuel cartridge against the discharge ports 36 of the receptacle 30. The receptacle 30 further includes a means 40 for controlling the opening and closing of the valve 18 within the fuel cartridge.

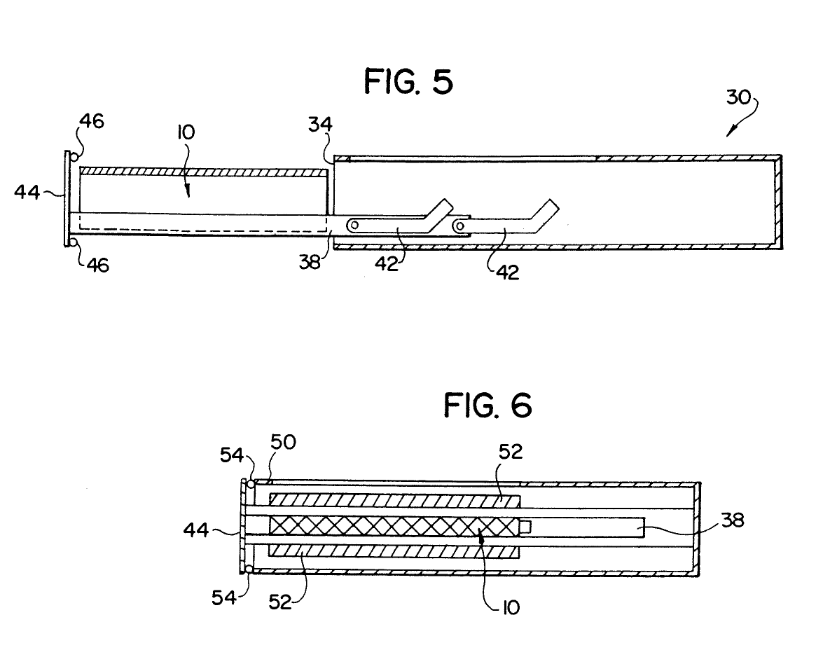

In one embodiment, as shown in FIG. 5, which shows a cartridge 10 positioned in the tray 38, the tray 38 in the receptacle 30 slides along guides 42 to ensure proper positioning of the tray 38 and cartridge 10. The tray can move in and out of the receptacle manually, or preferably with an automated motor, drive, and control system. Automated motor, drive, and control systems are known as shown in U.S. Pat. No. 4,722,078; U.S. Pat. No. 5,572,498; U.S. Pat. No. 6,452,893; U.S. Pat. No. 6,477,133; U.S. Pat. No. 6,490,238; and U.S. Pat. No. 6,510,122, which are incorporated by reference. An automated system provides for proper positioning and a more consistent operation. The receptacle has a door 44 that opens when the tray 38 extends out of the receptacle 30, and closes when the tray 38 retracts into the receptacle 30. The door 44 is affixed to the tray 38 and is positioned on the tray 38 to cover the insertion port 34 when the tray 38 is retracted into the receptacle 30. Optionally, the door 44 is attached with a hinge to the receptacle and automatically opens when the tray 38 extends out of the receptacle 30 and automatically closes when the tray 38 retracts into the receptacle 30. The door 44 may include a spring to automatically close the door 44.

The tray 38 consists of a rigid framework in which the fuel cartridge is placed. The tray 38 has an open structure which allows for free flow of gas out of the exit ports of the fuel cartridge 10. Preferably, the tray 38 has a snap-in configuration to position the cartridge 10 more precisely when the cartridge 10 is drawn into the receptacle 30. A snap-in configuration is a design wherein the cartridge is shaped to fit with a relatively close tolerance into the cartridge tray. The cartridge further has a slot or protrusion that fits into a corresponding protrusion or slot in the tray respectively, such that when the cartridge is placed in the tray the corresponding slot and protrusion snap together.

In one embodiment, the door 44 when closed is sealed to isolate the fuel cartridge 10 from the exterior of the fuel cartridge receptacle 30. In this embodiment, a seal is affixed around the edge of the door 44, or the edge of the insertion port 34. The seal is comprised of an elastomeric, or other, material that is deformable under the slight compression when the door 44 is closed over the insertion port 34. Optionally, the door 44 includes a latch (not shown) for maintaining the door 44 in a closed position when the door 44 is closed. Release of the latch may either be a manual or an automated process when the door 44 is opened. When the door 44 is closed and sealed, the fuel cartridge can release fuel to the receptacle discharge port 36. This enables a structure that has a closed and sealed compartment in which the fuel cartridge is placed.

In an alternate embodiment, the fuel cartridge includes an elastomeric seal in a surrounding relationship to the cartridge outlet. The cartridge outlet is covered with a hydrophobic membrane 20, and therefore the seal surrounds the membrane 20. The cartridge outlet is sized and shaped to conform with the discharge port 36 of the fuel cartridge receptacle 30. The cartridge is inserted into the tray 38 and is brought into the receptacle. The cartridge is then pressed against the discharge port 36 of the fuel cartridge receptacle 30 forming an airtight seal. The means for pressing the cartridge can be manual or automatic. Means include, but are not limited to, guides in the receptacle for guiding the tray into position, a levered means for pressing the cartridge and tray against the discharge port when the tray is retracted into the receptacle, and a motor that is activated when the tray is in the retracted, or closed, position and then presses the cartridge against the discharge port 36.

The fuel cartridge receptacle 30 can be part of a fuel cell. This structure enables the positioning of the fuel in close proximity to the anode in a fuel cell and minimizes the creation of ducts or channels to direct gaseous fuel over the fuel cell anodes.

In one embodiment, the invention includes a fuel cell, as shown in FIG. 6, and is shown in cross section. The fuel cell comprises a housing 50 and within the housing a membrane electrode assembly (MEA) 52 is disposed. An MEA comprises an anode, a cathode, and an ion conducting material positioned between the anode and cathode forming a layered stack. The fuel cell housing 50 includes a cartridge tray port and defines a space for a fuel cartridge. A fuel cartridge tray 38 is attached to the fuel cell in slideable manner, and can move between an open position and a closed position through the cartridge tray port. The cartridge tray 38 can receive a fuel cartridge 10 when in the open position, and bring the fuel cartridge into the defined space when in the closed position. The MEA 52 is positioned within the defined space with the anode side of the MEA facing the space defined for the fuel cartridge 10. This brings the fuel in close proximity to the anode.

The fuel cell further includes a door 44 for covering the cartridge tray port. The door 44 seals the defined space when the door 44 is closed. To form the seal a sealing material 54 such as a gasket is positioned around the edge of the door 44 can contacts the housing to form a seal. Alternatively, the seal 54, or gasket, can be positioned on the housing 50 around the cartridge tray outlet, forming a seal when the door is closed. In one embodiment, the door 44 is affixed to the cartridge tray 38, and opens when the cartridge tray 38 moves to the open position, and closes when the cartridge tray 38 is retracted to the closed position. Alternately, the door is hingeably attached to the housing and swings open and closed over the cartridge tray outlet. The door can include springs to provide sufficient tension to hold the door against the housing in a sealed condition.

The gasket can be any material that is impermeable to air, and is sufficiently flexible to form a seal when the door is pressed against the housing. Materials for the gasket include, but are not limited to, deformable thermoplastics such as polyethylene, polypropylene, co-polymers of ethylene and propylene, co-polymers of acrylonitrile and butadiene, fluorocarbon elastomers, polyurethane elastomers, silicone, synthetic and natural rubbers, and fabrics impregnated with a material to make the fabric impermeable to air.

The fuel cell is preferably of a size and shape convenient for use in a portable electronic device. A preferred shape is a rectangular prism, or box shape, with dimensions of a height of less than 4 cm, a width from about 5 to 15 cm, and a depth from about 5 to 30 cm. The box shape is a convenient shape to fit within a laptop computer, and preferably has a small height to conform to the size limitations of a laptop computer.

Preferably, the fuel cell comprises two MEAs positioned within the defined space and in opposite orientations, one on top and one on the bottom, with their anode sides facing the cartridge tray. This provides a large area for the anodes. A preferred fuel cartridge has a large exit port on the top of the cartridge and a large exit port on the bottom of the cartridge with each port covered by a hydrophobic membrane. This configuration provides a relatively large anode surface area exposed in close proximity to the fuel. The preferred embodiment further includes a seal around the door to provide a sealed fuel chamber with a minimum of air space around the cartridge. While the fuel cell and fuel cell cartridge are described in an orientation with a “top” and a “bottom”, the use of solid fuel permits any configuration and is not restricted to such an orientation.

While the invention has been described in connection with what is presently considered to be the most practical and preferred embodiment, it is to be understood that the invention is not limited to the disclosed embodiments, but, on the contrary, is intended to cover various modifications and equivalent arrangements within the spirit and scope of the appended claims which scope is accorded the broadest interpretation so as to encompass all such modifications and equivalent structures as is permitted under the law.

What is claimed is:

1. A fuel cell system comprising:
a housing having a cartridge tray port, and said housing defining a space for a fuel cartridge;
a fuel cartridge tray for holding the fuel cartridge having a rigid open framework, slideably attached to the housing and moveable through the cartridge tray port between an open position and a closed position; and
at least one MEA disposed within the housing, wherein the MEA has an anode side and a cathode side and the anode side of the MEA is facing the space for the fuel cartridge tray.

2. The fuel cell system of claim 1 further comprising a door affixed to the fuel cartridge tray or to the housing and positioned to cover the cartridge tray port when the fuel cartridge tray is in the closed position.

3. The fuel cell system of claim 1 wherein the housing has a substantially rectangular prismatic structure and further comprising 2 MEAs, disposed within the housing on opposing sides of the fuel cartridge tray, with each MEA anode side facing the fuel cartridge tray.
